(19) United States
(12) Patent Application Publication
(10) Pub. No.: US 2025/0252469 A1
(43) Pub. Date: Aug. 7, 2025

(54) DATA VERIFICATION OF BEVERAGE ORDER DISPATCH SYSTEMS, METHODS, AND DEVICES

(71) Applicant: WE SCAN, LLC, Southlake, TX (US)

(72) Inventors: Greg Groff, Keller, TX (US); Jesse Crabbe, Irving, TX (US)

(21) Appl. No.: 19/045,622

(22) Filed: Feb. 5, 2025

Related U.S. Application Data
(60) Provisional application No. 63/549,596, filed on Feb. 5, 2024.

(51) Int. Cl. G06Q 30/0601

(52) U.S. Cl. CPC G06Q 30/0609; G06Q 30/0637

(57) ABSTRACT

Systems, methods, and devices include a transaction data verification service of a beverage order dispatch system. The system receives a request to initiate an order transaction at one or more retailer computing device associated with a retail establishment. The one or more retailer computing devices determine that the request corresponds to a restricted item. In response, the system performs the transaction data verification service. The transaction data verification service includes an age verification procedure to determine whether an age of a user providing the request meets a predefined age limit value. The transaction verification service also includes an inebriation assessment procedure to calculate an alcohol consumption estimate associated with the user. The inebriation assessment procedure calculates a standardized drink unit value based on an order history of the user. Upon receiving a verification input at the retailer device(s), the restricted item is added to a check associated with the user.

### CROSS-REFERENCE TO RELATED APPLICATIONS

The present application claims priority to U.S. Provisional Patent Application No. 63/549,596 filed on Feb. 5, 2024, which is incorporated by reference in its entirety herein.

### FIELD

Aspects of the presently disclosed technology relate generally to data verification systems and more particularly to transaction data verification of beverage order dispatch systems.

### BACKGROUND

Many retail establishments offer a variety of alcoholic beverages for sale to customers. To order an alcoholic beverage, a customer typically places an order with the server or bartender and waits for the order to arrive. The amount of time to complete this process and receive a beverage can vary significantly depending on the size of the establishment, the number of drink options, the decisiveness of the customer, the number of working employees, and the number of other customers at the establishment also ordering drinks.

Meanwhile, staff at the establishment are tasked with verifying the age requirements and the level of inebriation of the customers to ensure the legal requirements for purchasing alcohol are met. Staff are also encouraged to sell and distribute a high volume of beverages drinks as efficiently as possible. Mistakes by the staff with respect to the age of the alcohol purchaser or their level of verification can result in penalties, or even the loss of the establishment's liquor license.

It is with these observations in mind, among others, that various aspects of the present disclosure were conceived and developed.

### SUMMARY

Implementations described and claimed herein address the foregoing problems by providing systems, methods, and devices of data verification for a beverage order dispatching system. A method can include receiving, at one or more retailer computing device associated with a retail establishment, a request to initiate an order transaction; and determining, at the one or more retailer computing device that the order transaction corresponds to a restricted item. The method can also include, responsive to the order transaction corresponding to the restricted item, performing a transaction data verification service. The transaction data verification service can include: an age verification procedure to determine whether an age of a user providing the request meets a predefined age limit value; and/or an inebriation assessment procedure to calculate an alcohol consumption estimate associated with the user. The inebriation assessment procedure can involve calculating a standardized drink unit value based on an order history of the user. Additionally, the method can include presenting, at the one or more retailer computing device, a textual reminder to perform the transaction data verification service; receiving a verification input at the one or more retailer computing device approving or denying the request; and/or determining whether to add the restricted item to a check associated with the user based on the verification input.

In some instances, the transaction data verification service forms part of a beverage order dispatching system. Calculating the standardized drink unit value can include accessing a standardized drink schema stored at a database of the beverage order dispatching system. The method can also include receiving one or more retail personnel inputs for configuring one or more verification parameters of the transaction data verification service. For instance, the one or more verification parameters can include at least one of: a first age threshold value for the user; a second age threshold value for a selling retail personnel; valid sale hours associated with the retail establishment; one or more manager review triggers; and/or a time between drink purchases value. Moreover, the age verification procedure can include presenting a prompt, at the one or more retailer computing device and with the textual reminder, requesting an approval input. Furthermore, the transaction data verification service can form part of a beverage order dispatching system. Calculating the standardized drink unit value can include receiving drink-related data from the order history associated with the user; receiving a drink conversion value from a standardized product schema stored at a database of the beverage order dispatching system; and/or converting the drink-related data into the standardized drink unit value using the drink conversion value.

In some examples, the transaction data verification service forms part of a beverage order dispatching system, and the age verification procedure can include: receiving a date of birth value responsive to a login into the beverage order dispatching system occurring at a user device; and/or comparing the date of birth value to the predefined age limit value. The method can also include presenting a manager user interface (UI) at the one or more retailer computing device. The manager UI can include an interactive element which, upon receiving a user input, presents verification data related to a particular retail personnel. Also, the verification data can include a first number of verifications performed by the particular retail personnel based on an ID scan, and/or a second number of verifications performed by the particular retail personnel based on a visual assessment. The method can also include presenting a manager UI at the one or more retailer computing device, the manager UI including an interactive element which, upon receiving a user input, presents order history data related to at least one of the user, a seat associated with the user, or a table associated with the user. Moreover, determining whether to add the restricted item to a check associated with the user based on the verification input can include sending an instruction to a point-of-sale (POS) system to add the restricted item to the check.

In some examples, a method of data verification for beverage order dispatching can include determining, at one or more retailer computing device, that a request for an order transaction corresponds to a restricted item; responsive to the order transaction corresponding to the restricted item, performing a transaction data verification service which includes at least one of: an age verification procedure to determine whether an age of a user providing the request meets a predefined age limit value based on an identification (ID) card scan; and/or an inebriation assessment procedure to calculate an alcohol consumption estimate associated with the user, the inebriation assessment procedure calculating a standardized drink unit value based on an order history of the user. The method can also include presenting, at the one or more retailer device, a reminder to perform the transaction data verification service; receiving a verification input at the one or more retailer computing device approving or denying the request; and/or determining whether to add the restricted item to a check associated with the user, at a Point-of-Sales (POS) system, based on the verification input.

In some instances, the method can also include receiving one or more retail device inputs for configuring one or more verification parameters of the transaction data verification service, the one or more verification parameters including an acceptable type of verification input. The acceptable type of verification input can be selected from a group including: the ID card scan; a visual ID card assessment; and/or a visual age assessment of the user. The reminder can also include a textual reminder to retail personnel to remember previous verification training.

In some examples, a method of data verification for beverage ordering dispatching can include determining, at one or more retailer computing device associated with a retail establishment, that a request for an order transaction corresponds to a restricted item. Also, responsive to the order transaction corresponding to the restricted item, the method can perform a transaction data verification service which includes at least one of: an age verification procedure to determine whether an age of a user providing the request meets a predefined age limit value; and/or an inebriation assessment procedure to determine an alcohol consumption estimate associated with the user. The method can also include presenting, at the one or more retailer computing device, a reminder to perform the transaction data verification service; receiving a verification input at the one or more retailer computing device approving the request; and/or adding the restricted item to a check associated with the user, at a Point-of-Sales (POS) system associated with the retail establishment, based on the verification input.

In some examples, the inebriation assessment procedure can include calculating a standardized drink unit value based on an order history of the user that includes drink-related data, and a drink conversion value retrieved from a standardized product schema stored at a database of a beverage order dispatching system. Also, the verification input can be a type of verification input including at least one of an identification (ID) card scan, a visual ID card assessment, or a visual age assessment of the user. Additionally, the one or more retailer computing device can include a first retail device, and the method can further include triggering, at a second retail device and responsive to the type of verification input, a notification for a manager review of the age verification procedure. Furthermore, determining, at the one or more retailer computing device, that the request for an order transaction corresponds to the restricted item can include accessing restricted item category data cached locally at the one or more retailer computing device.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example data verification system for beverage order dispatching.

FIG. 2 illustrates an example data verification system for beverage order dispatching including a verification prompt.

FIG. 3 illustrates an example data verification system for beverage order dispatching including a manager user interface (UI).

FIG. 4 illustrates an example network environment for implementing a data verification system for beverage order dispatching.

FIG. 5 illustrates example computing devices of a data verification system for beverage order dispatching.

FIG. 6 illustrates an example method of data verification for beverage order dispatching.

### DETAILED DESCRIPTION

Aspects of the present disclosure involve systems, methods, and devices of transaction data verification, which can be used with a beverage order dispatch system of a retail establishment. The systems disclosed herein can facilitate communications between one or more retailer devices, user devices, and/or a point-of-sale (POS) system connected to the retailer device. The beverage order dispatch service can include a transaction verification service to be used as an aid or tool for assisting the retail personnel in determining whether or not to serve a user. The transaction data verification service can reduce or eliminate human error from the process of evaluating a customer's age and/or level of inebriation when the customer attempts to purchase an alcoholic beverage. Moreover, the transaction data verification service can streamline the verification process to improve data processing and storage efficiencies for the establishment's computer infrastructure. Additionally, the techniques disclosed herein can create a digital record of verification activity, associated with the retail personnel performing the verification procedures, which can be stored at databases for later auditing/review of the retail personnel's performance.

Additional advantages of the disclosed technology will become apparent from the detailed description below.

Furthermore it is to be understood that the technology disclosed herein can be used as a tool to assist retailers in making their assessment but is not intended as a replacement for the personal judgment of retailers, or the responsibility of end customers. Additionally, various scenarios can arise including those created by bad actors. A customer may obtain drinks outside of the establishment and/or can conceal their level of inebriation. Other examples of bad actors involve the use of fraudulent identification cards. As such, the technology disclosed herein is supplemental to the human-made decisions at the establishment.

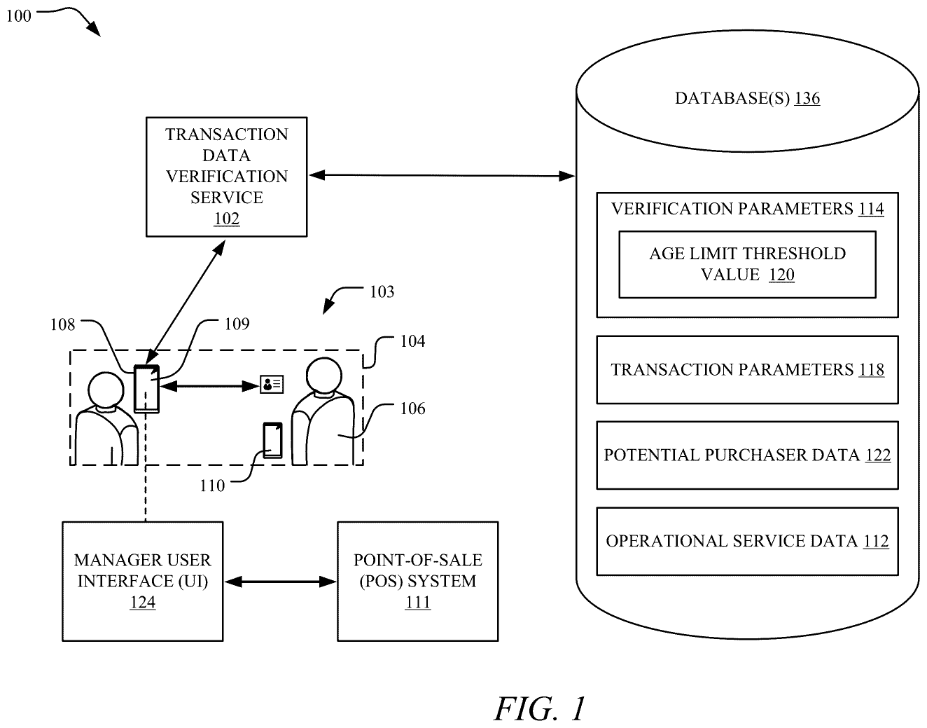

FIGS. 1-5 illustrate an example system 100 including a transaction data verification service 102 of a beverage ordering system 403. The transaction data verification service 102 can be used to perform a transaction verification procedure 103 in which legal requirements of beverage orders at a retail establishment 104 are verified. The transaction data verification service 102 can be triggered in response to an attempt to add a restricted item to an order of the beverage ordering system 403. The transaction data verification service 102 can facilitate interactions among a retailer device 108 associated with the retail establishment 104, one or more user device(s) 110, and/or a point-of-sale (POS) system 111 associated with the retailer device 108 to ensure one or more purchase requirements are satisfied when the user 106 (e.g., the customer) initiates the transaction.

As shown in FIG. 1, the transaction data verification service 102 can receive, generate, store, and/or send operational service data 112 to facilitate the transaction verification procedure 103 between the user device(s) 110 and the retailer device 108. The operational service data 112 can include timestamped data generated by the retailer device 108 and the POS system 111 representing the details of transactions occurring at the retail establishment 104 (e.g., the purchaser identity, the order item details, the purchase location, etc.). Additionally, the transaction data verification service 102 can include a settings package with verification parameters 114 which are configurable by the retailer device 108 via one or more prompts, text fields, or the like. The verification parameters 114 can control/modify the operations of an age verification procedure 204 and/or an inebriation assessment procedure 206 of the transaction data verification service 102.

For instance, the configurable verification parameters 114 can include an age limit threshold value 120 indicating the age requirement for qualifying for the transaction. The retailer device 108 can present one or more user interface element(s) at a retailer user interface (UI) 109 with a field for entering the age limit threshold value 120. The retailer UI 109 can also include a toggleable feature that can be switched between an 18 years old threshold and a 21 years old threshold (e.g., to correspond to different state law requirements). The retailer device 108 can also receive a second age limit threshold value indicating an age limit for the retail personnel (e.g., the bartender, server, manager, etc.) selling the restricted item. This second age limit threshold value can be 18 years old or 21 years old and can be a different value than the first age limit threshold value 120.

Furthermore, the configurable verification parameters 114 can include valid sale hours, such as the hours of operation of the retail establishment 104, which can be provided via user inputs at the retailer device 108. Additional configurable verification parameters 114 can include whether the transaction data verification service 102 generates and presents a notification alert at the retailer device 108, such as at a manager UI 124, triggered by an occurrence of a restricted sale. Furthermore, a time limit threshold for adding a new seat to a table (e.g., 15 minutes or 30 minutes) can also be a configurable verification parameter 114. Other configurable verification parameters 114 that can be enabled or disabled at the retailer device 108 can include allowing a manager override; requiring a manager to swipe a card for approval; whether to prompt for verification responsive to only a first restricted item request for the user 106; whether a drink can be moved to an unauthorized seat; and/or whether drinks can be moved away from the seat at which the drink is purchased. The configurable verification parameters 114 can also include whether to present a button for receiving an input indicating that the guest is over age; whether to enable visual verification; and/or whether to display the born-on date during the verification procedure.

Moreover, what type of user data is stored during the verification procedure can also be a configurable parameter. For instance, personally identifiable information (PII) can be excluded from data storage, or certain identifying information can be stored to satisfy particular state law reporting requirements. As such, the transaction data verification service 102 can be customizable by the retailer device 108 to match the operational capabilities and needs of the retail establishment 104, and/or the legal jurisdiction in which the retail establishment 104 operates.

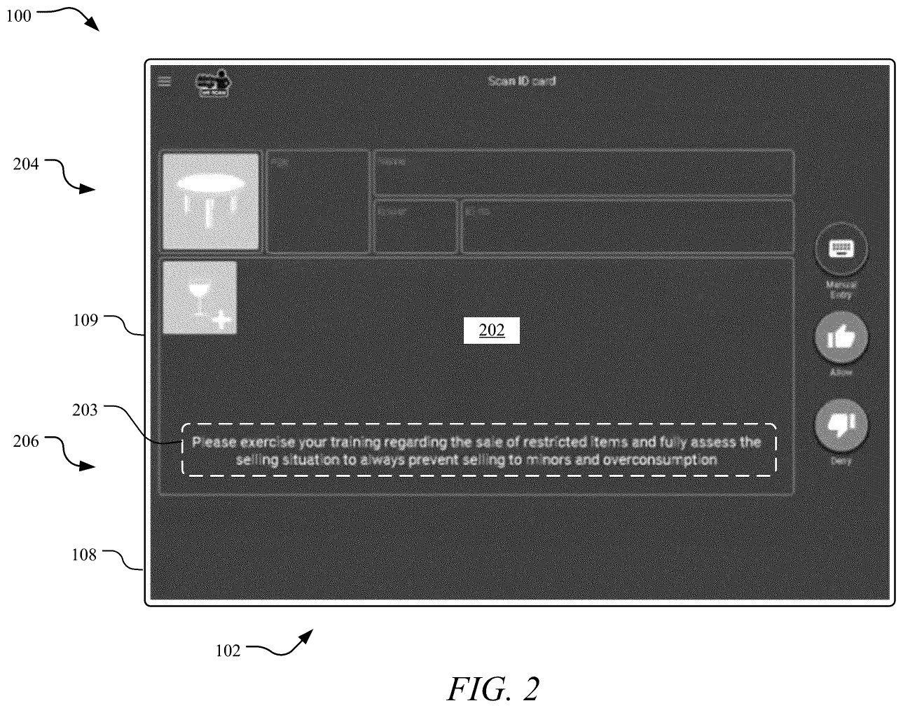

As shown in FIG. 2, in some instances, the transaction data verification service 102 can perform an age verification procedure 204 as part of the transaction verification procedure 103. For example, the transaction data verification service 102 can present one or more user interface prompts 202 at the retailer device 108 for the retail establishment personnel (e.g., bartender) to confirm an age of the user 106. The transaction data verification service 102 can present one or more prompts 202 at the retailer device 108 (e.g., or the user device 110 in communication with the retailer device 108) to enter a birth date, driver's license information, and/or to scan or photograph the driver's license (e.g., and extract personal data from the driver's license via an image recognition program). The transaction data verification service 102 can present one or more prompts 202 at the retailer device 108 to request an approval input from the retail establishment personnel that age verification has occurred for the user 106. Additionally or alternatively, the transaction data verification service 102 can receive the birth date of the user 106 responsive to a login action at a user device 110, for instance, when the user device 110 logs into the beverage ordering system 403 of the retail establishment 104. The birth date can be compared to the age limit threshold value 120 to determine whether the age verification procedure 204 is satisfied and/or whether the purchase is an approved purchase or a denied purchase.

In some examples, the transaction data verification service 102 can perform an inebriation assessment procedure 206 as part of the transaction verification procedure 103. The inebriation assessment procedure 206 can include one or more calculations to determine an estimate of a previous amount of alcohol consumed by the potential purchaser (e.g., the user 106), and/or a level of inebriation of the potential purchaser. The transaction data verification service 102 can collect drink-related data associated with the potential purchaser (e.g., potential purchaser data 122), which is compared to one or more predefined transaction parameters 118 to perform the inebriation assessment procedure 206. The one or more transaction parameters 118 can be threshold values stored in one or more database(s) 136 of the transaction data verification service 102, such as a total drink count limit value; and/or a time between drinks value (e.g., 15 minutes). These transactions parameters 118 can be configurable by the retailer device 108 via one or more user inputs, for instance, as one or more of the verification parameters 114. The potential purchaser data 122 can be any data associated with the particular user 106 requesting to purchase a drink, including at least one of a name or identifier associated with the user 106; a total drink count associated with the user 106; a drink count-per-unit time value associated with the user 106 (e.g., a number of drinks in the last hour); and/or a time since a last drink purchase associated with the user 106 (e.g., using a timer that initiates upon the last drink purchase of the user 106).

The transaction data verification service 102 can also perform one or more conversion calculations as part of the inebriation assessment procedure 206. For instance, any of the drink-related values discussed herein can be calculated by collecting drink purchase data 303 associated with the user 106 and/or converting the drink purchase data to a standardized alcohol unit 304. The transaction data verification service 102 can receive or access drink data (e.g., from the database 136) indicating an alcohol percent associated with a particular drink purchase (e.g., an Alcohol by Volume (ABV) value) and/or volume (e.g., ounces or milliliters) associated with the particular drink purchase. The transaction data verification service 102 can use this information as a conversion value for converting particular drink purchases into a standardized drink value (e.g., with one standardized drink unit being approximately 14 grams/0.6 ounces of alcohol). The transaction data verification service 102 can use a count indicating a number of standardized drinks, based on this conversion, to calculate the drink-related potential purchaser data 122.

Furthermore, the transaction data verification service 102 can track table seating associated with the user 106 and can carry various transaction parameters 118 associated with the user 106 over to a new table responsive to the user relocating. For instance, in response to determining that the user 106 has moved to a different table, a drink count and/or a timer since a last drink purchase associated with the user 106 can be associated with the new table. The transaction data verification service 102 can use POS system data to make determinations related to the user's table seating and/or table changes.

In some examples, the prompt 202 to approve or deny a restricted item is triggered to be displayed in response to the first restricted item associated with the user 106 being added to their check. The prompt 202 can provide the user interface for executing the age verification procedure 204 and/or the inebriation assessment procedure 206. For instance, the prompt 202 can indicate the item for purchase, the associated table number, and/or an option to scan the ID of the user 106. As such, the prompt 202 can provide a three-way verification between the information on the ID, the information presented on the prompt 202, and information gleaned from a visual inspection of the user 106. The prompt 202 can receive a user input (e.g., retailer input) denying the restricted item, in which case, the item is removed from the check. Alternatively, the prompt 202 can receive a user input approving the restricted item, thus adding the restricted item to the check. The prompt 202 can present a reminder 203 to the retailer personnel (e.g., a textual reminder and/or an audio reminder) to perform the transaction verification procedure 103 and/or to exercise their training. The prompt 202 can also receive an interaction indicating that a particular retail personnel approves or denies the transaction.

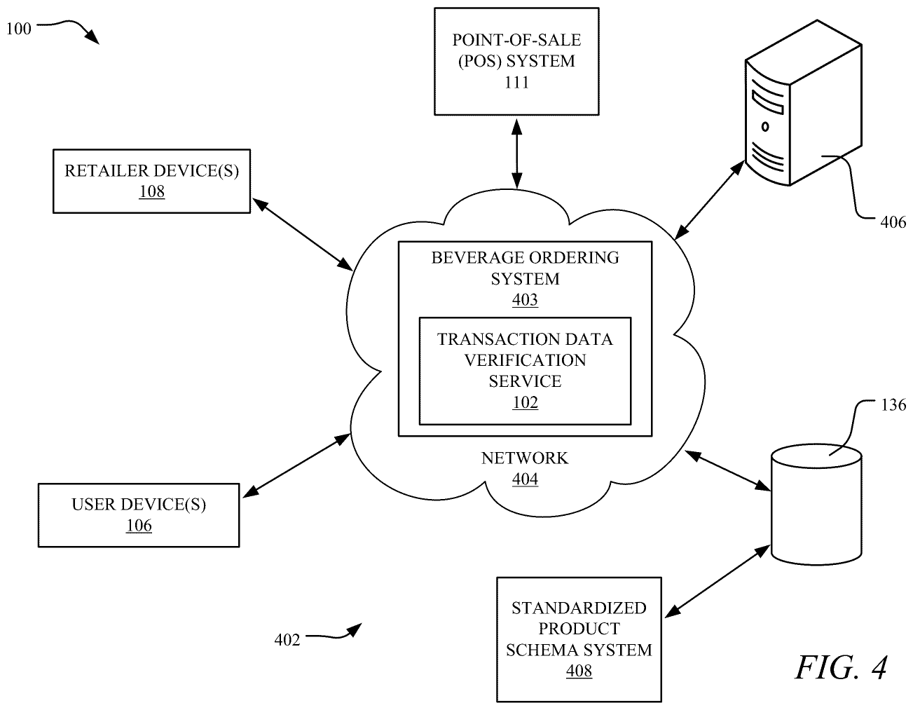

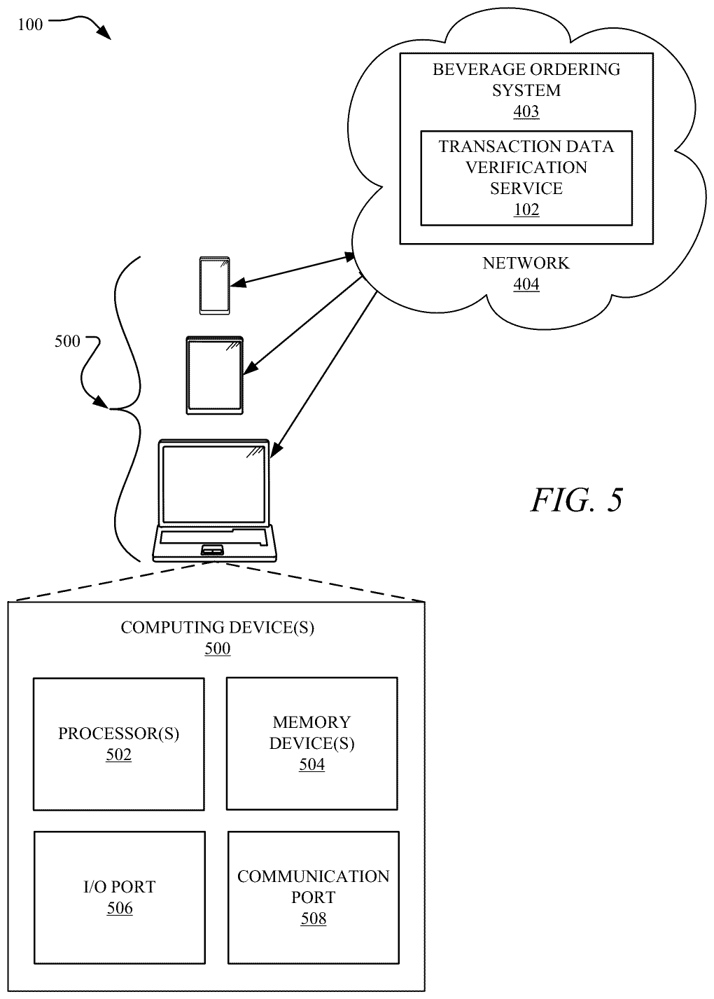

Furthermore, the prompt 202 can present an indication of whether the restricted item fails to satisfy one of the transaction parameter(s) 118, with a textual explanation (e.g., “The alcohol drink limit has been reached for this user,” “less than 15 minutes have elapsed since the last drink purchase for this user,” and so forth). In response to the restricted item failing to satisfy one of the transaction parameter(s) 118, the prompt 202 can present an option for receiving a manager override input. Furthermore, the prompt 202 can indicate how an approval would cause the restricted item to fail the transaction parameter (e.g., “This is the fourth drink for this customer,” “This drink sale is outside approved sale hours,” etc.) Additionally, in some instances, the manager can provide approval responsive to the request for a manager override input at a different device than the retailer device 108, such as another retailer device 108, a device of the POS system 111 (e.g., executing an application or plugin of the transaction data verification service 102), and/or a web browser. The various devices used to implement the transaction data verification service 102 are discussed in greater detail below regarding FIGS. 4 and 5.

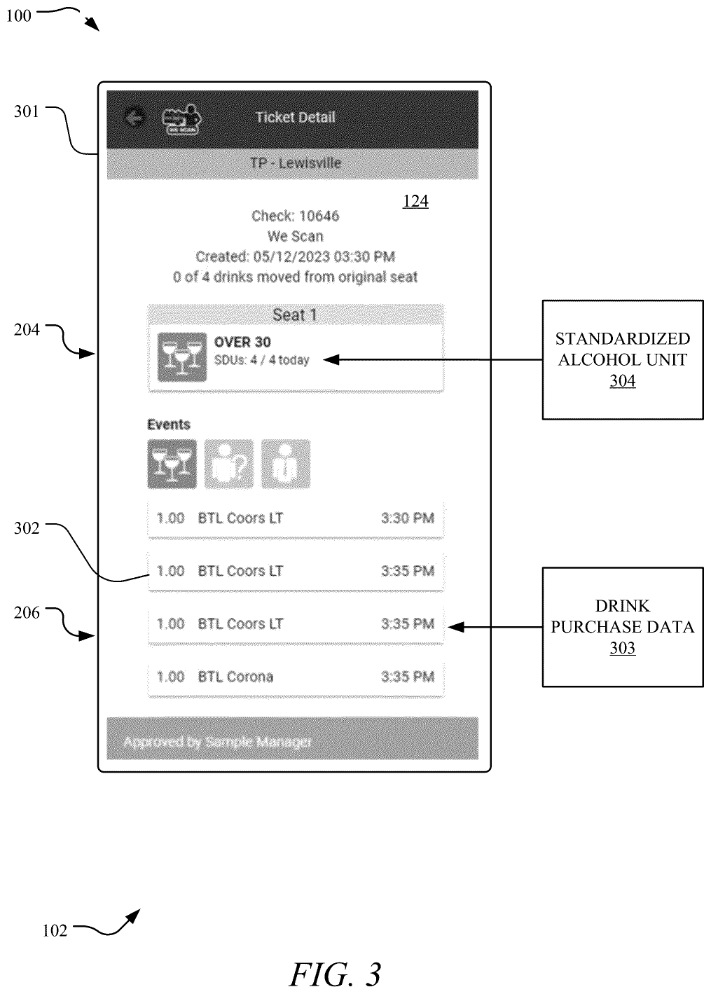

As shown in FIGS. 2 and 3, in some examples, the transaction data verification service 102 can provide a retailer user interface (UI) 109 at the retailer device 108 to facilitate the age verification procedure 204 and/or the inebriation assessment procedure 206. The retailer UI 109 can be similar to, identical to, and/or can include the prompt 202 depicted in FIG. 2. For instance, the retailer UI 109 can include one or more verification input prompts to receive an input from the retail personnel (e.g., a manager) confirming and approving the drink transaction. The verification input can include a PIN, a biometric input (e.g., voice or face confirmation), and/or a card swipe or scan. The transaction data verification service 102 can trigger a request for manager approval based on any of the predefined transaction parameters 118 discussed above not being met. As noted above, the retailer UI 109 can be presented at a same retailer device 108 used to initiate the transaction verification procedure 103 and/or at a different retailer device 108.

Additionally, as shown in FIG. 3, the retailer UI 109 can present other UI screens/prompts in addition to or alternatively to the prompt 202 for purchase approval/denial. For example, the UI 109 can generate and/or present one or more purchase status reports 302 indicating current drink purchase statuses for a particular user 106, a seat, a table, a group of tables, or the whole retail establishment 104. The retail personnel can cross-reference the purchase status report with a visual inspection of the user 106, the seat, the table, the group of tables, and/or retail establishment 104 to identify discrepancies and/or determine if an unauthorized drink purchase occurred. The purchase status reports 302 presented at the retailer UI 109 can also include a list of users, tables, or group of tables, shown with corresponding purchased drink units (e.g., the standardized drink units). In some instances, the data for the purchases status reports 302 can be received at least in part from the POS system 111 (e.g., via one or more API calls to and from the POS system and the retailer device 108).

In some instances, the transaction data verification service 102 can use a distributed data architecture for retail establishments 104 that have multiple locations. For instance, a database(s) 136 at a master or primary location can store the threshold values for the age verification procedure 204 and/or the inebriation assessment procedure 206 (e.g., the verification parameters 114, the transaction parameters 118, etc.). Moreover, the primary location database can store menu data corresponding to the retail establishment 104, which can be used for generating the alcohol volume calculations (e.g., by providing the drink volume data and/or the drink ABV data). The primary location database can also store a standardized product schema 408 including the alcohol conversion values and other detailed information regarding the drink offerings of the retail establishment 104. Additionally, the transaction data verification service 102 can receive retailer device inputs indicating which items correspond to a “restricted” category requiring the transaction verification procedure, and which items are unrestricted (e.g., non-alcoholic beverages). The indication of whether an item is a restricted item or not can be received during an “add item” inventory procedure of the beverage ordering system 403, for example, by cross-referencing a database 136 storing the item information. Furthermore, this data, as well as any data received at the retailer device 108 discussed herein, can be received at a primary retailer device 108 of the centralized primary location, and can be pushed to additional retailer devices 108 located at additional retail establishment locations. Furthermore, any of the procedures or individual operations of the procedures can be performed at the centralized location (e.g., at a centralized server 406) to reduce processing/data requirements at the local terminals (e.g., local retailer devices 108). In some examples, the restricted item categories and/or drink count data can be cached and/or stored at the local retailer device 108 of the various retail establishment locations. As such, the data processing and storage requirements for the transaction data verification service 102 can have improved data processing and/or storage efficiencies, especially for retail establishment 104 with many locations.

In some instances, the retailer UI 109 can provide access to an order history interface 301 for any user 106, seat, or table, including the various drink-related calculations and potential purchaser data 122 (e.g., via a UI selectable element or tab on the retailer UI 109). This data can show every purchase associated with that user 106, seat, or table, as well as the time(s) of the purchase(s), and the information used to verify the purchase(s). Whether a manager override approval occurred can be provided via the order history interface 301 as well as at the prompt 202.

In some scenarios, the transaction data verification service 102 can include a server tracking service to generate, store, and/or archive retail personnel activity related to the transaction verification procedure 103. For instance, the database(s) 136 can store data indicating the retail personnel's interactions with the prompt(s) 202 that provide the different types of verification. The different types of verification can include whether the retail personnel scanned the user's ID; whether the retail personnel indicated that the user 106 appears over 30 years old based on a visual assessment of the user 106; whether the retail personnel approved the transaction; and/or whether the retail personnel denied the transaction. Reports can be generated using the retail personnel data indicating, for a particular retail personnel, a number of manager override, a number of network timing exceptions (e.g., network timing-based data processing errors), and the like. The retailer UI 109 can also access the retail personnel-related data generated by the server tracking service, for instance, by presenting an amount of times the different verification types were used by a particular server (e.g., the number of visual assessment approvals and/or the number of ID scan-based approvals). This data can be retrieved, for example, if the retail establishment 104 has an incident in which they need to prove or understand what occurred during the transaction verification procedure 103. Moreover, this data can be accessed by the manager in real-time to monitor a current verification performance of the retail establishment 104. Additionally, the transaction data verification service 102 can be used to review/audit the retail personnel's performance regarding their execution of transaction verification procedure 103, and can be aggregated over an extended period (weeks, months, years, etc.) as part of a quarterly, bi-annual, or annual performance review of the retail personnel.

In some examples, the transaction data verification service 102 can provide multi-device access to the transaction verification procedure 103. For example, the transaction data verification service 102 can be implemented as one or more application(s) at the retailer device 108 and the user device(s) 110, as well as a browser web portal hosted by a server 406. Accordingly, the potential purchaser data 122 can be provided to the users 106 at their own user device 110, such that the users 106 can see their own drink-related data and can monitor their own level of drink consumption/inebriation.

Turning to FIG. 4, an example system 100 can include a network environment 402 for implementing the transaction data verification service 102 using the retailer device 108, the POS system 111, and/or the user device(s) 110. The beverage ordering system 403, which can provide the transaction data verification service 102, can interact with the various systems through a network 404 (e.g., using one or more network connections). The network 404 can include any type of network, such as the Internet, an intranet, a Virtual Private Network (VPN), a Voice over Internet Protocol (VoIP) network, a wireless network (e.g., Bluetooth), a cellular network (e.g., 4G, 5G, LTE, etc.), satellite, combinations thereof, etc. The network 404 can include communications network(s) with numerous components such as, but not limited to gateways routers, servers, and registrars, which enable communication across the network 404. In one implementation, the communications network(s) includes multiple ingress/egress routers, which may have one or more ports, in communication with the network 404. The user device(s) 110, the retailer device(s) 108, and/or the POS system 111 can access and be accessed by the network 404 via the communications network, which may be a public switched telephone network (PSTN) operated by a local exchange carrier (LEC) and/or a wireless network, as discussed above.

The transaction data verification service 102 (e.g., and/or the beverage ordering system 403) can also include at least one server 406 hosting a website or application that the retailer device 108 and/or the user device(s) 110 may visit to access the transaction data verification service 102. The website or application can receive the inputs from the retailer device 108 and the user device(s) 110 and can analyze the inputs to generate outputs for the transaction data verification service 102. The server 406 may be a single server, a plurality of servers with each such server being a physical server or a virtual machine, or a collection of both physical servers and virtual machines. In another implementation, a cloud hosts one or more components of the transaction data verification service 102. The server 406 may represent an instance among large instances of application servers in a cloud computing environment, a data center, or other computing environment. The server 406 can access the data stored at the one or more database(s) 136. The retailer device(s) 108, the user device(s) 110, the POS system 111, the server 406, and/or other resources connected to the network 404 may access one or more other servers to access one or more websites, applications, web services interfaces, storage devices, computing devices, or the like, to provide the transaction data verification service 102. Furthermore, as noted above the server 406 can be a centralized server 406 at a primary retail establishment location and can push data to multiple other retailer devices 108 at multiple locations of the retail establishment 104.

In some instances, the retailer device(s) 108 can include one or more of desktop computers, laptops, tablets, phones, or other devices, as discussed in greater below regarding FIG. 5. The retailer device(s) 108 can be any combination of back-office devices and front-of-the-house devices. Moreover, the retailer device(s) 108 can include corporate management devices of the retail establishment 104 at a different location from the retail establishment 104 (e.g., a remote location or central office). The retailer device(s) 108 can communicate with or be partially or fully integrated with the POS system(s) 111.

In some scenarios, the POS system 111 can include one or more computing device (e.g., special purpose computing devices) at the retail establishment 104, or in remote communication with the retailer device 108 at the retail establishment 104, for executing transactions between the retail establishment 104 and users 106 at the retail establishment 104. For instance, the POS system 111 can include one or more of a card or chip reader, a kiosk, a terminal, a mobile POS (e.g., a tablet or a smart phone), a barcode scanner, a cash drawer, a keyboard, a receipt printer, and the like. The POS system 111 can include software to manage and execute beverage order transactions responsive to inputs and outputs of the transaction data verification service 102. For instance, the POS system 111 can use one or more transaction category codes for tracking and identifying particular items in the transactions. In some instances, the beverage ordering system 403 integrates the transaction data verification service 102 into the POS system 111 by mapping transaction category codes of the POS system 111 (e.g., a “restricted item” category or a “non-restricted” category) to the product identifiers. The product identifiers can also be linked to the standardized product schema 408, which can be used to calculate the standardized drink units.

As shown in FIGS. 4 and 5, the network environment 402 can include one or more computing device(s) 500 for operating the transaction data verification service 102. In one implementation, the one or more computing device(s) 500 include the retailer device(s) 108, the user device(s) 110, the POS system 111, the server 406, the database(s) 136 hosting the transaction data verification service 102, and/or any other devices forming the various systems discussed herein.

In one implementation, the computing device(s) 500 use the beverage ordering system 403 for real-time, interactive beverage ordering with the transaction data verification service 102. For instance, the beverage ordering system 403 can host beverage ordering sessions and transmit and receive text, HTML, video, image, and audio data to and from the user device(s) 110 and/or the retailer device(s) 108. In one implementation, multiple user devices 110 can each host an application facilitating communication between other user devices 110, the retailer device 108 and/or the server 406 of the transaction data verification service 102. The server 406 can maintain a list of identifiers (e.g., at the database(s) 136) including user device identifiers associated with the user device(s) 110, retailer device identifier(s) associated with the retail device(s) 108, POS system identifiers associated with the POS system 111, POS category identifiers associated with the POS system transaction categories, product identifiers identifying beverage products, recipes, and other beverage-related data (e.g., organized according to the standardized product schema 408), and/or other identifiers. Within the network environment 402, the transaction data verification service 102 may facilitate beverage ordering for multiple users 106 and multiple retail establishments 104 independent of the type of user device 110 or the type of the retailer device 108 being utilized.

In some instances, the computing device(s) 500 (e.g., the retailer device 108, the user device(s) 110, the POS system 111, etc.) can include a computer, a personal computer, a desktop computer, a laptop computer, a terminal, a workstation, a cellular or mobile phone, a mobile device, a smart mobile device, a tablet, a wearable device (e.g., a smart watch, smart glasses, a smart epidermal device, etc.), a multimedia console, a television, an Internet-of-Things (loT) device, a smart home device, a virtual reality (VR) or augmented reality (AR) device, and/or the like. It will be appreciated that specific implementations of these devices may be of differing possible specific computing architectures.

The computing device 500 may be a computing system capable of executing a computer program product to execute a computer process. Data and program files may be input to the computing device 500, which reads the files and executes the programs therein. Some of the elements of the computing device 500 can include one or more hardware processors 502, one or more memory devices 504, and/or one or more ports, such as input/output (IO) port(s) 506 and communication port(s) 508. Various elements of the computing device 500 may communicate with one another by way of the communication port(s) 508 and/or one or more communication buses, point-to-point communication paths, or other communication means.

The processor 502 may include, for example, a central processing unit (CPU), a microprocessor, a microcontroller, a digital signal processor (DSP), a graphics processing unit (GPU), and/or one or more internal levels of cache. There may be one or more processors 502, such that the processor 502 comprises a single central-processing unit, or a plurality of processing units capable of executing instructions and performing operations in parallel with each other, commonly referred to as a parallel processing environment.

The computing device 500 may be a single computer, a plurality of computers (e.g., a distributed computer), or any other type of computer, such as one or more external computers made available via a cloud computing architecture. The presently described technology is optionally implemented in software stored on the data storage device(s) such as the memory device(s) 504, and/or communicated via one or more of the ports 506 and 508, thereby transforming the computing device 500 in FIG. 5 to a special purpose machine for implementing the operations described herein.

The one or more memory device(s) 504 may include any non-volatile data storage device capable of storing data generated or employed within the computing device 500, such as computer executable instructions for performing a computer process, which may include instructions of both application programs and an operating system (OS) that manages the various components of the computing device 500. The memory device(s) 504 may include, without limitation, magnetic disk drives, optical disk drives, solid state drives (SSDs), flash drives, and the like. The memory device(s) 504 may include removable data storage media, non-removable data storage media, and/or external storage devices made available via a wired or wireless network architecture (e.g., the network environment 402) with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 504 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 504 which may be referred to as machine-readable media. It will be appreciated that machine-readable media may include tangible non-transitory medium capable of storing or encoding instructions to perform operations of the transaction data verification service 102. The machine-readable media can store computer-readable instructions for execution by a machine, and/or can be capable of storing or encoding data structures and/or modules utilized by or associated with such instructions.

In some implementations, the computing device 500 includes one or more ports, such as the I/O port 506 and the communication port 508, for communicating with other computing, network, or devices. It will be appreciated that the I/O port 506 and the communication port 508 may be combined or separate and that more or fewer ports may be included in the computing device 500.

The I/O port 506 may be connected to an I/O device, or other device, by which information is input to or output from the computing device 500. Such I/O devices may include, without limitation, one or more input devices and/or output devices. The input devices can convert a human-generated signal, such as, human voice, physical movement, physical touch or pressure, and/or the like, into electrical signals as input data into the computing device 500 via the I/O port 506. Similarly, the output devices may convert electrical signals received from the computing device 500 via the I/O port 506 into signals that may be sensed as output by a human, such as sound, light, and/or touch. The input device may be an alphanumeric input device, including alphanumeric and other keys for communicating information and/or command selections to the processor 502 via the I/O port 506. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, an accelerometer; and/or a touch-sensitive display screen (“touchscreen”). The output devices may include, without limitation, a display, a touchscreen, a speaker, a tactile or haptic output device, and/or the like. In some implementations, the input device and the output device may be the same device, for example, in the case of a touchscreen.

In one implementation, the communication port 508 is connected to the network 404, and the computing device 500 may receive network data useful in executing the methods and systems set out herein as well as transmitting information and network configuration changes determined thereby. Stated differently, the communication port 508 can connect the computing device 500 to one or more communication interface devices configured to transmit and/or receive information between the computing device 500 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 508 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 508 may communicate with an antenna or other link for electromagnetic signal transmission and/or reception.

In an example implementation, retailer data (e.g., the operational service data 112, the verification parameters 114, the transaction parameters 118, etc.); user device data (e.g., order history data and/or potential purchaser data 122); the standardized product schema 408; other data for facilitating the transaction verification procedure 103; software; and other modules and services may be embodied as data structures and/or instructions stored on the memory devices 504 and executed by the processor 502.

The system(s) set forth in FIGS. 4 and 5 are examples of a computer system that may employ or be configured in accordance with aspects of the present disclosure. It will be appreciated that other non-transitory tangible computer-readable storage media storing computer-executable instructions for implementing the transaction data verification service 102 on a computing system and/or in a network environment may be utilized. In the present disclosure, the methods disclosed may be implemented as sets of instructions or software readable by the computing device 500. Further, it is understood that the specific order or hierarchy of steps in the methods disclosed are instances of example approaches.

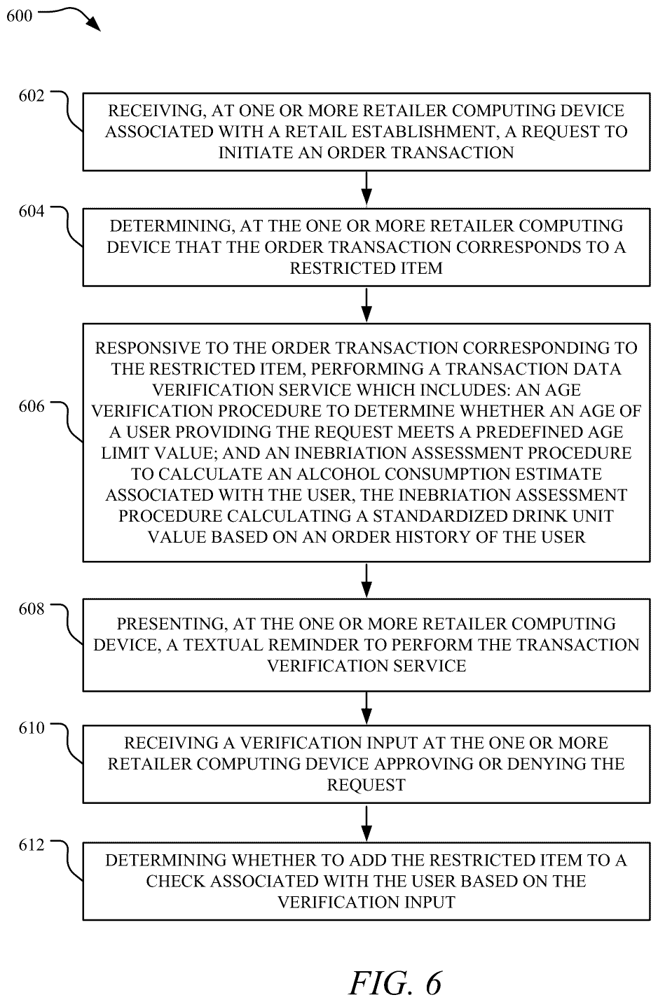

FIG. 6 illustrates an example method 600 for providing a data verification procedure, which can be performed by any of systems 100 discussed herein.

For instance, at operation 602, the method 600 can receive, at one or more retailer computing device associated with a retail establishment, a request to initiate an order transaction. At operation 604, the method can determine, at the one or more retailer computing device that the order transaction corresponds to a restricted item. At operation 606, the method 600 can, responsive to the order transaction corresponding to the restricted item, perform a transaction data verification service which includes: an age verification procedure to determine whether an age of a user providing the request meets a predefined age limit value; and an inebriation assessment procedure to calculate an alcohol consumption estimate associated with the user, the inebriation assessment procedure calculating a standardized drink unit value based on an order history of the user. At operation 608, the method 600 can present, at the one or more retailer computing device, a textual reminder to perform the transaction data verification service. At operation 610, the method 600 can receive a verification input at the one or more retailer computing device approving or denying the request. At operation 612, the method 600 can determine whether to add the restricted item to a check associated with the user based on the verification input.

It is to be understood that the specific order or hierarchy of operations in the method depicted in FIG. 6 and throughout this disclosure are instances of example approaches and can be rearranged while remaining within the disclosed subject matter. For instance, any of the operations depicted in FIG. 6 and throughout this disclosure may be omitted, repeated, performed in parallel, performed in a different order, and/or combined with any other of the operations depicted in FIG. 6 and throughout this disclosure. Any of the operations performed by the system 100 to provide transaction data verification services 102 and/or beverage ordering services can be included in the method 600.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method of data verification for beverage order dispatching, the method comprising:
receiving, at one or more retailer computing device associated with a retail establishment, a request to initiate an order transaction;
determining, at the one or more retailer computing device that the order transaction corresponds to a restricted item;
responsive to the order transaction corresponding to the restricted item, performing a transaction data verification service which includes:
an age verification procedure to determine whether an age of a user providing the request meets a predefined age limit value; and
an inebriation assessment procedure to calculate an alcohol consumption estimate associated with the user, the inebriation assessment procedure calculating a standardized drink unit value based on an order history of the user;
presenting, at the one or more retailer computing device, a textual reminder to perform the transaction data verification service;
receiving a verification input at the one or more retailer computing device approving or denying the request; and
determining whether to add the restricted item to a check associated with the user based on the verification input.

2. The method of claim 1, wherein the transaction data verification service forms part of a beverage order dispatching system, and calculating the standardized drink unit value includes:
accessing a standardized drink schema stored at a database of the beverage order dispatching system.

3. The method of claim 2, further comprising:
receiving one or more retail personnel inputs for configuring one or more verification parameters of the transaction data verification service.

4. The method of claim 3, wherein the one or more verification parameters includes at least one of:
a first age threshold value for the user;
a second age threshold value for a selling retail personnel;
valid sale hours associated with the retail establishment;
one or more manager review triggers; or
a time between drink purchases value.

5. The method of claim 1, wherein the age verification procedure includes presenting a prompt, at the one or more retailer computing device and with the textual reminder, requesting an approval input.

6. The method of claim 1, wherein the transaction data verification service forms part of a beverage order dispatching system, and calculating the standardized drink unit value includes:
receiving drink-related data from the order history associated with the user;
receiving a drink conversion value from a standardized product schema stored at a database of the beverage order dispatching system; and
converting the drink-related data into the standardized drink unit value using the drink conversion value.

7. The method of claim 1, wherein the transaction data verification service forms part of a beverage order dispatching system, and the age verification procedure includes:
receiving a date of birth value responsive to a login into the beverage order dispatching system occurring at a user device; and
comparing the date of birth value to the predefined age limit value.

8. The method of claim 1, further comprising:
presenting a manager user interface (UI) at the one or more retailer computing device, the manager UI including an interactive element which, upon receiving a user input, presents verification data related to a particular retail personnel.

9. The method of claim 8, wherein the verification data includes a first number of verifications performed by the particular retail personnel based on an ID scan, and a second number of verifications performed by the particular retail personnel based on a visual assessment.

10. The method of claim 1, further comprising:
presenting a manager user interface (UI) at the one or more retailer computing device, the manager UI including an interactive element which, upon receiving a user input, presents order history data related to at least one of the user, a seat associated with the user, or a table associated with the user.

11. The method of claim 1, wherein determining whether to add the restricted item to a check associated with the user based on the verification input includes sending an instruction to a point-of-sale (POS) system to add the restricted item to the check.

12. A method of data verification for beverage order dispatching, the method comprising:
determining, at one or more retailer computing device, that a request for an order transaction corresponds to a restricted item;
responsive to the order transaction corresponding to the restricted item, performing a transaction data verification service which includes at least one of:
an age verification procedure to determine whether an age of a user providing the request meets a predefined age limit value based on an identification (ID) card scan; or
an inebriation assessment procedure to calculate an alcohol consumption estimate associated with the user, the inebriation assessment procedure calculating a standardized drink unit value based on an order history of the user;
presenting, at the one or more retailer computing device, a reminder to perform the transaction data verification service;
receiving a verification input at the one or more retailer computing device approving or denying the request; and
determining whether to add the restricted item to a check associated with the user, at a Point-of-Sales (POS) system, based on the verification input.

13. The method of claim 12, further comprising receiving one or more retailer computing device inputs for configuring one or more verification parameters of the transaction data verification service, the one or more verification parameters include an acceptable type of verification input.

14. The method of claim 13, wherein the acceptable type of verification input is selected from a group including:
the ID card scan;
a visual ID card assessment; and
a visual age assessment of the user.

15. The method of claim 12, wherein the reminder includes a textual reminder to retail personnel to remember previous verification training.

16. A method of data verification for beverage order dispatching, the method comprising:
determining, at one or more retailer computing device associated with a retail establishment, that a request for an order transaction corresponds to a restricted item;
responsive to the order transaction corresponding to the restricted item, performing a transaction data verification service which includes at least one of:
an age verification procedure to determine whether an age of a user providing the request meets a predefined age limit value; and
an inebriation assessment procedure to determine an alcohol consumption estimate associated with the user;
presenting, at the one or more retailer computing device, a reminder to perform the transaction data verification service;
receiving a verification input at the one or more retailer computing device approving the request; and
adding the restricted item to a check associated with the user, at a Point-of-Sales (POS) system associated with the retail establishment, based on the verification input.

17. The method of claim 16, wherein the inebriation assessment procedure includes calculating a standardized drink unit value based on an order history of the user that includes drink-related data, and a drink conversion value retrieved from a standardized product schema stored at a database of a beverage order dispatching system.

18. The method of claim 16, wherein the verification input is a type of verification input including at least one of an identification (ID) card scan, a visual ID card assessment, or a visual age assessment of the user.

19. The method of claim 18, wherein the one or more retailer computing device includes a first retail device, and the method further includes triggering, at a second retail device and responsive to the type of verification input, a notification for a manager review of the age verification procedure.

20. The method of claim 16, wherein determining, at the one or more retailer computing device, that the request for the order transaction corresponds to the restricted item includes accessing restricted item category data cached locally at the one or more retailer computing device.
